(19) United States
(12) Patent Application Publication
(10) Pub. No.: US 2025/0315341 A1
(43) Pub. Date: Oct. 9, 2025

(54) COMPUTER SYSTEM AND FAULT HANDLING SUPPORT METHODS FOR IT SYSTEM

(71) Applicant: Hitachi, Ltd., Tokyo (JP)

(72) Inventors: Taku WAKUI, Tokyo (JP); Mineyoshi MASUDA, Tokyo (JP); Kiyomi WADA, Tokyo (JP)

(21) Appl. No.: 19/092,210

(22) Filed: Mar. 27, 2025

(30) Foreign Application Priority Data
Apr. 3, 2024 (JP) 2024-060181

(51) Int. Cl. G06F 11/07

(52) U.S. Cl. CPC G06F 11/0793; G06F 11/0709

(57) ABSTRACT

A computer system is connected to an IT system and a text generation system that generates a text according to a prompt, and holds event log information for managing event logs of events that have occurred in the IT system and scope information for managing a scope that is a condition for acquiring event logs of events related to a designated event. The computer system receives a fault handling request including information on a target event related to a fault, generates related event information by collecting the event logs from the event log information based on a plurality of scopes, generates a prompt for an instruction to analyze a state of the IT system using a plurality of pieces of related event information and generate an analysis text indicating an analysis result, and transmits the prompt to the text generation system.

### CLAIM OF PRIORITY

The present application claims priority from Japanese patent application JP 2024-060181 filed on Apr. 3, 2024, the content of which is hereby incorporated by reference into this application.

### BACKGROUND OF THE INVENTION

### 1. Field of the Invention

The present invention relates to a system and a method for supporting handling a fault of an IT system.

### 2. Description of the Related Art

When handling a fault of an IT system, operation information such as logs of events that have occurred in the IT system, configuration information of the IT system, and performance value information is analyzed to grasp a state of the IT system, and then a cause of the fault is identified and the fault is handled. When identifying the cause of the fault and handling the cause, a manual, a system specification, and the like are referred to as necessary.

In order to grasp the state of the IT system, it is necessary to extract and analyze not only operation information at the time when the fault was confirmed but also information that may be related to the fault among operation information obtained before the fault occurred. There are several prior art techniques for extracting information that are considered related to a fault from the vast amount of information.

US 2019/0286500 A1 discloses an automated or semi-automated system and method for analyzing event data, the method including clustering events that have the same content or that occurred at the same location, extracting one or more templates from each cluster, extracting one or more regular expressions from each cluster; and grouping events having similar regular expressions.

In addition, recently, a utilization method of generating a text indicating a state of an IT system with information such as time stamps, messages, and sources from which a plurality of events have been generated as an input using an advanced natural language processing capability of a large language model (LLM) has also been proposed.

### SUMMARY OF THE INVENTION

In US 2019/0286500 A1, in order to analyze event data, event groups are clustered, one or more templates are extracted from each of the clusters, one or more regular expressions are extracted from each of the clusters, and events having similar regular expressions are grouped.

Various definitions can be considered with respect to a condition for acquiring an event log (event data) related to an event indicating a fault. For example, the condition is defined as an event having a similar message, an event occurring in close temporal proximity, an event occurring at the same node or at an adjacent node with reference to configuration information, or the like.

When an event log acquisition condition is different, an extracted event log group is also different, and an analysis result thereof also changes. If the extracted event log group does not include an event log indicating the cause of the fault, the state of the IT system cannot be accurately grasped from the information obtained from the analysis, and the fault cannot be appropriately handled. For example, in a case where a related event that is a direct or indirect factor of a certain event has occurred 3 hours before the time when the certain event occurred, if a time range up to 1 hour before from the time point at which the certain event occurred is set as an acquisition condition, an event log of the related event cannot be acquired.

The present invention provides a system and a method for completely acquiring and analyzing information on related events necessary for grasping a state of an IT system in which a fault has occurred.

A representative example of the invention disclosed in the present application is as follows. That is, a computer system includes a processor, a storage device connected to the processor, and a network interface connected to the processor, in which the computer system is connected to an IT system including a plurality of nodes and a text generation system that generates an answer text according to a prompt for an instruction to execute a language processing task using a natural language processing model, the computer system holds event log information for managing event logs of events that have occurred in the IT system and scope information for managing a scope that is a condition for acquiring event logs of events related to a designated event, definition information for a plurality of scopes is stored in the scope information, and the processor is configured to: receive a fault handling request including information on a target event related to a fault; generate related event information by collecting the event logs from the event log information based on each of the plurality of scopes; and generate a prompt for an instruction to analyze a state of the IT system using each of a plurality of pieces of the related event information and generate a first analysis text indicating a result of the analysis, and transmit the prompt to the text generation system.

According to the present invention, by acquiring event logs based on a plurality of scopes, it is possible to suppress the omission of event logs necessary for grasping the state of the IT system in which a fault has occurred. In addition, a text indicating the state of the IT system can be acquired by using an LLM. Other problems, configurations, and effects that are not described above will be apparent from the following description of embodiments.

### BRIEF DESCRIPTION OF THE DRAWINGS

FIG. 1 is a block diagram illustrating an example of a configuration of an IT system fault handling system according to a first embodiment of the present invention;

FIG. 2 is a diagram illustrating an example of event information according to the first embodiment;

FIG. 3 is a diagram illustrating an example of configuration information according to the first embodiment;

FIG. 4 is a diagram illustrating an example of related event information according to the first embodiment;

FIG. 5 is a diagram illustrating an example of analysis result information according to the first embodiment;

FIG. 6 is a flowchart illustrating an example of analysis processing executed by an analysis device according to the first embodiment;

FIG. 7 is a diagram illustrating an example of a management screen presented by the analysis device according to the first embodiment;

FIG. 8 is a flowchart illustrating an example of related event log acquisition processing executed by the analysis device according to the first embodiment;

FIG. 9 is a flowchart illustrating an example of analysis processing executed by the analysis device according to the first embodiment;

FIG. 10 is a flowchart illustrating an example of analysis result aggregation processing executed by the analysis device according to the first embodiment; and

FIG. 11 is a flowchart illustrating an example of answer information generation processing executed by the analysis device according to the first embodiment.

### DESCRIPTION OF THE PREFERRED EMBODIMENTS

Hereinafter, an embodiment of the present invention will be described with reference to the drawings. Note that the same components in the drawings for describing the embodiment are denoted by the same terms and reference signs as much as possible, and repeated description thereof will be omitted.

The present invention is not limited to the embodiment to be described later, and covers various modifications and equivalent configurations within the spirit of the appended claims. For example, the embodiment will be described in detail in order to explain the present invention in an easy-to-understand manner, and the present invention is not necessarily limited as having all the configurations to be described below.

In addition, for example, some or all of the processing units to be described in the embodiment may be realized by hardware by designing them as integrated circuits, or may be realized by software by the processors interpreting and executing programs for realizing the respective functions.

The tables, areas, and the like to be described in the embodiment may be a database (DB), or may be data stored in a main storage memory.

### First Embodiment

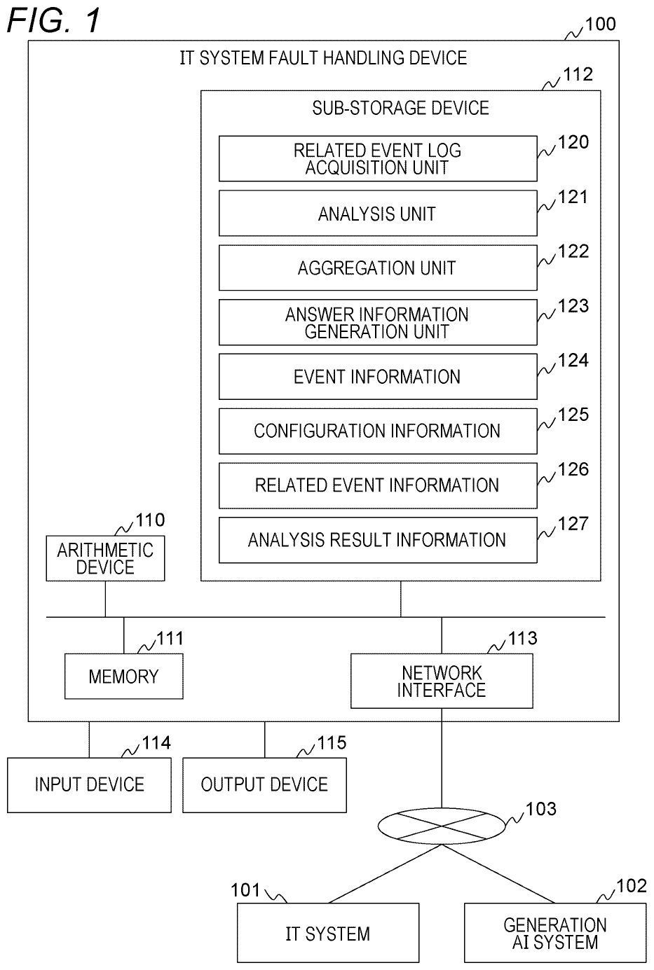

FIG. 1 is a block diagram illustrating an example of a configuration of an IT system fault handling system according to a first embodiment of the present invention.

The IT system fault handling system includes an analysis device 100, an IT system 101, and a text generation system 102.

The analysis device 100 is connected to the IT system 101 and the text generation system 102 via a communication network 103 such as the Internet, a LAN, a WAN, or a dedicated line. Note that the connection via the communication network 103 may be performed in either a wired manner or a wireless manner.

Note that although it is assumed that the IT system 101 and the text generation system 102 are connected to the same communication network 103, the IT system 101 and the text generation system 102 may be connected to the analysis device 100 via different communication networks.

The IT system 101 is a system to be monitored. The IT system 101 is a system constructed on a computer system including a plurality of computers, and includes a plurality of nodes. Examples of the nodes include hardware such as a server and a storage, software such as an OS, middleware, and an application, and services realized by the hardware and the software.

The text generation system 102 is a system that provides a service using an LLM. The LLM is a natural language processing model constructed using a large amount of text data, and can perform various language processing tasks. The LLM receives a prompt including task contents such as questions written in natural language, understands meanings of the task contents, and generates and outputs texts as answers. The LLM of the present embodiment is assumed to execute at least a task of analyzing a state of an IT system by using a log of an event of the IT system and generating a text indicating an analysis result. Note that the LLM is generated by learning processing using logs of events.

The analysis device 100 includes an arithmetic device 110, a memory 111, a sub-storage device 112, a network interface 113, an input device 114, and an output device 115.

The input device 114 is a keyboard, a mouse, a touch panel, or the like. The output device 115 is a display, a touch panel, or the like.

The arithmetic device 110 is a central processing unit (CPU) or the like. The arithmetic device 110 operate as a functional unit (module) that realizes a specific function by executing processing according to a program. In the following description, when processing is described using a functional unit as a subject, it indicates that the arithmetic device 110 executes a program for realizing the functional unit.

The memory 111 is a random access memory (RAM), a read only memory (ROM), or the like, and is a storage device into which the programs executed by the arithmetic device 110 and information used by the programs are loaded. The memory 111 is also used as a work area. The sub-storage device 112 is a hard disc drive (HDD), a solid state drive (SSD), or the like.

The network interface 113 is a network interface card (NIC), a wireless communication module, a universal serial interface (USB) module, a serial communication module, or the like.

The sub-storage device 112 stores programs for realizing a related event log acquisition unit 120, an analysis unit 121, an aggregation unit 122, and an answer information generation unit 123. In addition, the sub-storage device 112 stores event information 124, configuration information 125, related event information 126, and analysis result information 127.

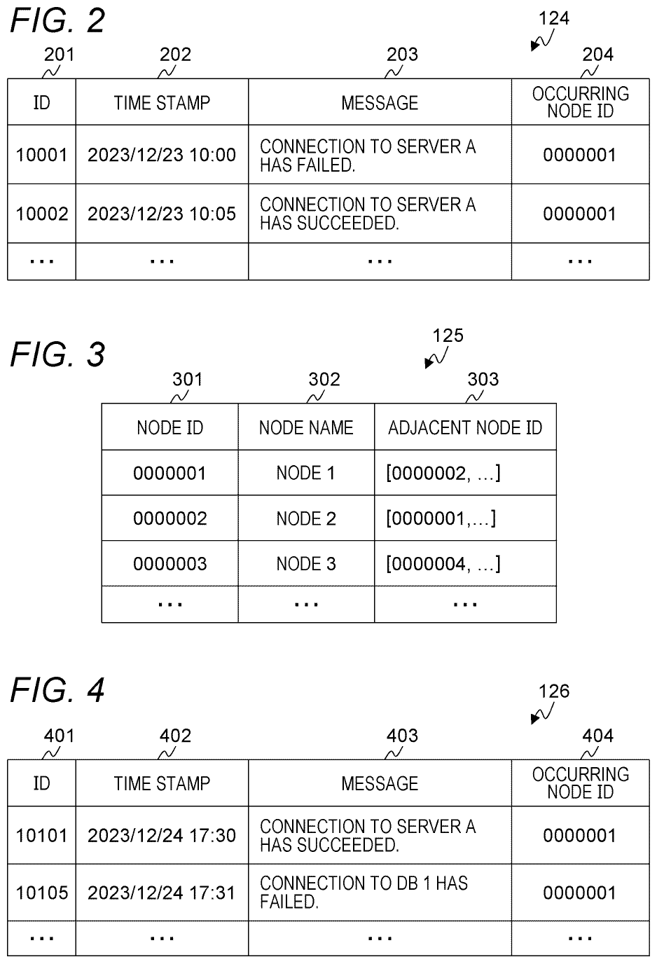

FIG. 2 is a diagram illustrating an example of the event information 124 according to the first embodiment.

The event information 124 stores a log of an event (event log) that has occurred in the IT system 101. The event information 124 stores an entry including an ID 201, a time stamp 202, a message 203, and an occurring node ID 204. One entry corresponds to one event log.

The ID 201 is a field for storing an identifier of an event log. The time stamp 202 is a field for storing a date and time when an event corresponding to the event log has occurred. The message 203 is a field for storing a message indicating a content of the event. The occurring node ID 204 is a field for storing an identifier of a node from which an event has occurred.

In the present embodiment, it is assumed that the IT system 101 collects event logs and transmits the collected event logs to the analysis device 100. Note that the analysis device 100 may collect event logs from the IT system 101.

FIG. 3 is a diagram illustrating an example of the configuration information 125 according to the first embodiment.

The configuration information 125 stores information regarding a node configuration of the IT system 101. The configuration information 125 stores an entry including a node ID 301, a node name 302, and an adjacent node list 303. One entry corresponds to one node.

The node ID 301 is a field for storing an identifier of a node. The node name 302 is a field for storing a name of the node. The adjacent node list 303 is a field for storing a list of nodes having a logical connection relationship with the node corresponding to the entry. The adjacent node list 303 stores a list of identifiers of nodes having a logical connection relationship with the node.

FIG. 4 is a diagram illustrating an example of the related event information 126 according to the first embodiment.

The related event information 126 is information generated from an event log of an event related to a target event (related event). The data structure of the related event information 126 is similar to that of the event information 124, and stores an entry including an ID 401, a time stamp 402, a message 403, and an occurring node ID 404.

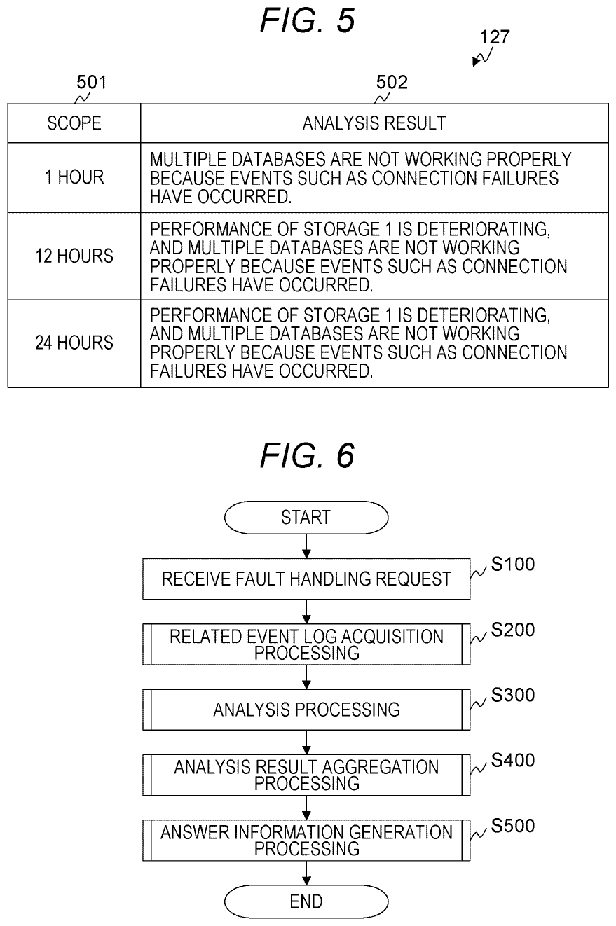

FIG. 5 is a diagram illustrating an example of the analysis result information 127 according to the first embodiment.

The analysis result information 127 is information that stores an event log analysis result. The analysis result information 127 stores an entry including a scope 501 and an analysis result 502. One entry corresponds to one analysis result.

The scope 501 is a field for storing a scope indicating an event log acquisition condition of an event related to a target event (related event). The scope is defined based on the time or the node configuration of the IT system 101. In the present embodiment, a plurality of scopes are set in advance. Note that the scope can be added, corrected, or deleted as appropriate. Note that the scope group may be switched according to the type of event, the analysis content, and the like.

The analysis result 502 is a field for storing an analysis result describing the state of the IT system 101. A text (analysis text) is stored in the analysis result 502. The analysis text includes one or more pieces of information (state information) indicating the state of the IT system.

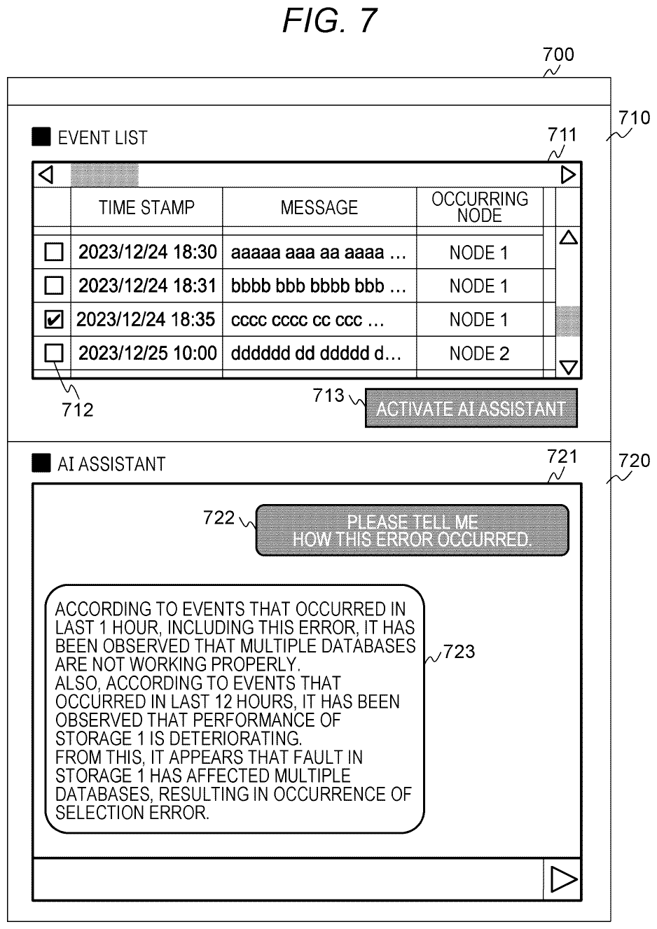

FIG. 6 is a flowchart illustrating an example of analysis processing executed by the analysis device 100 according to the first embodiment. FIG. 7 is a diagram illustrating an example of a management screen presented by the analysis device 100 according to the first embodiment.

When receiving access from a user, the analysis device 100 presents a management screen 700 as illustrated in FIG. 7. Here, the management screen 700 will be described. The management screen 700 includes an event selection area 710 and an AI assistant area 720.

The event selection area 710 includes an event list 711 and an operation button 713. The event logs stored in the event information 124 are displayed in the event list 711. The user selects a target event by operating a check box 712 of the event list 711. The operation button 713 is a button for activating an input to the AI assistant area 720.

The AI assistant area 720 is an area for inputting a fault handling request and outputting answer information, and includes a chat field 721. The user inputs a question sentence 722 indicating a handling content in the fault handling request to the chat field 721. The question sentence is, for example, “What is the cause?”, “How should it be handled?”, “What systems are affected?”, or the like. The analysis device 100 outputs answer information 723 to the fault handling request to the chat field 721.

The analysis device 100 receives a fault handling request via the management screen 700 (step S100).

Next, the related event log acquisition unit 120 of the analysis device 100 executes related event log acquisition processing (step S200). The related event log acquisition processing will be described in detail later.

Next, the analysis unit 121 of the analysis device 100 executes analysis processing in association with the text generation system 102 (step S300). The analysis processing will be described in detail later.

Next, the aggregation unit 122 of the analysis device 100 executes analysis result aggregation processing (step S400). The analysis result aggregation processing will be described in detail later.

Next, the answer information generation unit 123 of the analysis device 100 executes answer information generation processing (step S500). The answer information generation processing will be described in detail later.

In the present embodiment, the processing is executed with a user input as a starting point, but the present invention is not limited thereto. For example, the analysis device 100 holds information in which an event and a handling policy are associated with each other, monitors an event log, and generates a fault handling request including an event log of a specific event and a handling policy when an occurrence of the specific event is detected.

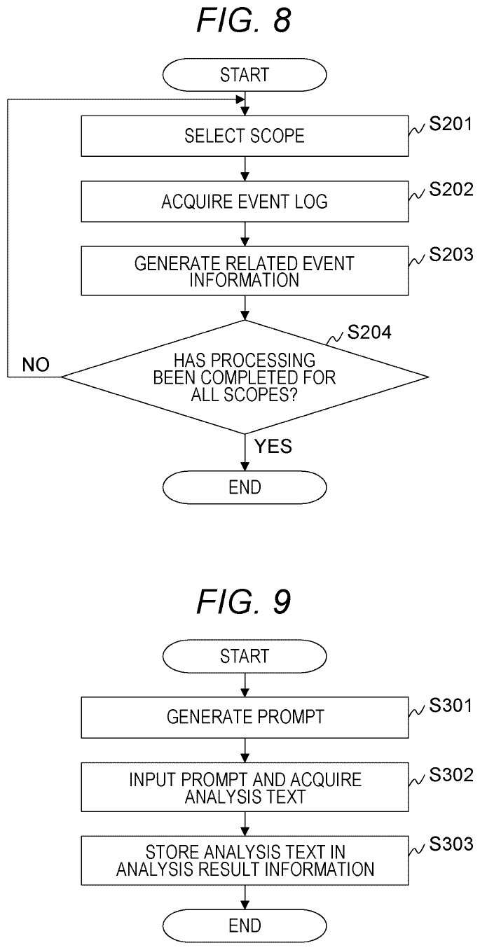

FIG. 8 is a flowchart illustrating an example of the related event log acquisition processing executed by the analysis device 100 according to the first embodiment.

The related event log acquisition unit 120 selects a scope (step S201).

The related event log acquisition unit 120 acquires an event log from the event information 124 based on the selected scope (step S202).

The related event log acquisition unit 120 generates related event information 126 from the acquired event log (step S203). At this time, the related event log acquisition unit 120 gives scope information as the related event information 126.

The related event log acquisition unit 120 determines whether the processing has been completed for all the scopes (step S204). When the processing has not been completed for all the scopes, the related event log acquisition unit 120 returns to step S201. When the processing has not been completed for all the scopes, the related event log acquisition unit 120 ends the related event log acquisition processing.

Here, a specific example of the scope will be described.

(Case 1) The scope defined from a viewpoint based on a time may be considered as follows.
(1) Time range up to 1 hour before from date and time of occurrence of target event
(2) Time range up to 12 hours before from date and time of occurrence of target event
(3) Time range from 24 hours before from date and time of occurrence of target event

For scope (1), the related event log acquisition unit 120 refers to the event information 124, acquires a time stamp of the target event, and sets a time range up to one hour before from the time stamp. The related event log acquisition unit 120 acquires event logs included in the set time range from the event information 124, and generates related event information 126. Similar processing is executed for scopes (2) and (3). Note that the time width to go back and the starting date and time are not limited to those described above.

Note that the time width to go back may be changed based on operation information of the IT system 101 or the like. For example, the analysis device 100 may manage a change history in which a date and time when a parameter related to the IT system 101, such as the configuration or specification of the IT system 101, and a change content is recorded, refer to the change history of the change applied immediately before the time stamp of the target event, and set the date and time of each change as a start point. The change history can be created using documents and information created and recorded by IT operation management, such as a configuration change record of the IT system 101, a change history of a specification, and a parameter sheet. By determining the time range for acquiring event logs based on the date and time when the change to the IT system 101 is applied, the acquired related event logs are restricted to event logs after the change, so that an event log related to a fault that the user wants to handle can be more efficiently extracted.

(Case 2) The scope defined from a viewpoint based on a node configuration of the IT system 101 may be considered as follows.
(4) Node at which target event has occurred
(5) Node adjacent to node at which target event has occurred

For scope (4), the related event log acquisition unit 120 acquires an event log of a node at which the target event has occurred from the event information 124, and generates related event information 126. For scope (5), the related event log acquisition unit 120 refers to the configuration information 125 to identify a node adjacent to the node at which the target event has occurred. The related event log acquisition unit 120 acquires an event log of the adjacent node from the event information 124, and generates related event information 126. In a case where there are a plurality of adjacent nodes, one piece of related event information 126 is generated from the event log of each adjacent node.

Note that the scope can be set by combining case 1 and case 2. For example, it may be considered to set “nodes at which target events have occurred in last 1 hour” as a scope.

FIG. 9 is a flowchart illustrating an example of the analysis processing executed by the analysis device 100 according to the first embodiment.

The analysis unit 121 generates a prompt for instructing analysis of the state of the IT system 101 using the event log included in the related event information 126 and generation of an analysis text indicating an analysis result (step S301). The prompt includes all the related event information 126 generated in the related event log acquisition processing, and the instruction of analysis and generation described above.

A prompt template is set in advance in the analysis device 100, and the analysis unit 121 generates a prompt by using the template.

The analysis unit 121 inputs the prompt to the text generation system 102 and acquires an analysis text (step S302).

The analysis unit 121 records the analysis text in the analysis result information 127 (step S303). Specifically, the analysis unit 121 records an entry in which the scope and the analysis text are associated with each other in the analysis result information 127.

Note that, in a case where a plurality of states are obtained as a result of analyzing one piece of related event information 126, an analysis text describing a relationship between the states may be generated. For example, an analysis text describing a causal relationship in which an occurrence of one state causes occurrence of another state may be generated.

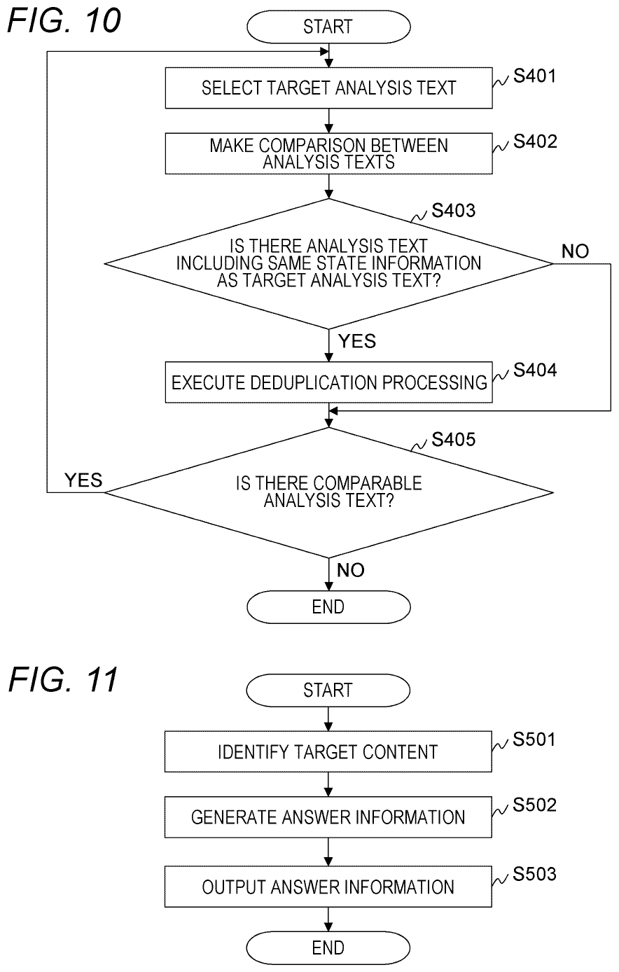

FIG. 10 is a flowchart illustrating an example of the analysis result aggregation processing executed by the analysis device 100 according to the first embodiment.

The aggregation unit 122 selects a target analysis text from the analysis result information 127 (step S401).

The aggregation unit 122 compares the target analysis text with analysis texts registered in the analysis result information 127 (step S402).

The aggregation unit 122 determines whether there is an analysis text including the same state information as the target analysis text (step S403).

When there is no analysis text including the same state information as the target analysis text, the aggregation unit 122 proceeds to step S405.

When there is an analysis text having the same content as the target analysis text, the aggregation unit 122 executes deduplication processing (step S404), and then proceeds to step S405.

For example, the aggregation unit 122 deletes overlapping state information from the target analysis text or the compared analysis text. In addition, the aggregation unit 122 merges the target analysis text and the compared analysis text into one analysis text. An analysis text including no state information is deleted.

In step S405, the aggregation unit 122 determines whether there is a comparable analysis text (step S405). Here, it is determined whether there is an analysis text that has not been selected as the target analysis text and has not been subjected to the deduplication processing.

When there is a comparable analysis text, the aggregation unit 122 returns to step S401. When there is no comparable analysis text, the aggregation unit 122 ends the analysis result aggregation processing.

Note that, with an analysis text (normal) generated in advance using an event log in a time zone in which no fault has occurred (e.g., one day before or one week before the date and time of the occurrence of the target event), the aggregation unit 122 may update the analysis text to leave only state information having a content different from the state information included in the analysis text (normal). As a result, only the state related to the fault of the IT system 101 can be extracted.

Note that the LLM may be caused to execute the analysis result aggregation processing. In this case, the aggregation unit 122 generates a prompt including analysis result information 127 and an instruction to compare analysis texts and merge or delete state information having the same content, and transmits the generated prompt to the text generation system 102. The aggregation unit 122 reflects a result of the deduplication of the analysis text performed by the text generation system 102 in the analysis result information 127.

FIG. 11 is a flowchart illustrating an example of the answer information generation processing executed by the analysis device 100 according to the first embodiment.

The answer information generation unit 123 identifies a handling content (step S501). For example, the answer information generation unit 123 identifies a handling content in the question sentence by executing text analysis processing.

Next, the answer information generation unit 123 generates answer information based on the analysis result information 127 and the handling content (step S502).

For example, when the handling content is “identification of fault”, the answer information generation unit 123 generates answer information from the analysis text stored in the analysis result information 127. When the handling content is “identification of cause”, the answer information generation unit 123 identifies a cause with reference to information such as a specification based on the analysis result information 127, and generates answer information for presenting the identified cause. When the handling content is “handling fault”, the answer information generation unit 123 identifies a handling method with reference to information such as a manual based on the analysis result information 127, and generates answer information for presenting the specified handling method.

Next, the answer information generation unit 123 outputs the answer information (step S503), and ends the answer information generation processing.

Note that answer information may be generated using an LLM. In this case, the answer information generation unit 123 transmits, to the text generation system 102, a prompt including a question sentence, an event log of a target event, analysis result information 127, and an instruction to generate answer information according to a handling content specified in the question sentence. In addition, answer information may be generated by an LLM using retrieval augmented generation (RAG). That is, the front-end application extracts a keyword from the analysis text, acquires information required for an answer by performing a keyword search by using a search tool, and inputs the acquired information and a prompt into the LLM. The LLM generates answer information based on the information and the prompt. The search tool is a web search engine API, a database storing information on related documents such as specifications and manuals, or the like.

Hereinafter, the present embodiment will be described using a specific example. Here, the following case is assumed. A fault occurs in the storage constituting the IT system, and a plurality of databases operate abnormally due to the fault. As a result, an error of a Web application depending on the databases is detected as an event. In addition, it is assumed that the scope of case 1 is set.

The analysis device 100 receives a fault handling request with an event indicating an error of the Web application as a target event (step S100).

In the related event log acquisition processing (step S200), the analysis device 100 acquires event logs in a time range (first time range) up to 1 hour before from the date and time when the error of the Web application occurred, and generates related event information 126. The analysis device 100 acquires event logs in a time range (second time range) up to 12 hours before from the date and time when the error of the Web application occurred, and generates related event information 126. The analysis device 100 acquires event logs in a time range (third time range) up to 24 hours before from the date and time when the error of the Web application occurred, and generates related event information 126.

The event logs in the first time range include an event log related to a database that is a cause of the error of the Web application. In addition, the event logs in the second time range include an event log related to a storage that is a cause of the abnormality of the operation of the database.

In the analysis processing (step S300), the analysis device 100 generates a first analysis text indicating the abnormality of the operation of the database using the related event information 126 generated from the event logs in the first time range. The analysis device 100 generates a second analysis text indicating the abnormality of the operation of the database and the fault of the storage using the related event information 126 generated from the event logs in the second time range. The analysis device 100 generates a third analysis text indicating the abnormality of the operation of the database and the fault of the storage using the related event information 126 generated from the event logs in the third time range.

In the analysis result aggregation processing (step S400), the analysis device 100 executes deduplication processing because the second analysis text and the third analysis text have the same content. Here, it is assumed that the third analysis text is deleted. In this case, the first analysis text and the second analysis text are stored in the analysis result information 127.

In the answer information generating process (step S500), the analysis device 100 generates answer information using the first analysis text and the second analysis text. For example, a text “a fault has occurred in the storage, causing an abnormality of an operation of the database, and further causing an error of the web application” is generated as answer information.

According to the present embodiment, by acquiring logs of related events in a plurality of scopes, it is possible to suppress the omission of the event log necessary for grasping the state of the IT system in which a failure has occurred. In addition, by using an LLM, it is possible to grasp the state of the IT system and appropriately handle a fault.

It should be noted that the present invention is not limited to the above-described embodiment, and includes various modifications. In addition, for example, the configurations of the above-described embodiment have been described in detail in order to explain the present invention in an easy-to-understand manner, and the present invention is not necessarily limited to having all the configurations described above. In addition, other configurations may be added to some of the configurations of each embodiment, some of the configurations of each embodiment may be deleted, or some of the configurations of each embodiment may be replaced with other configurations.

Further, some or all of the above-described configurations, functions, processing units, processing means, and the like may be realized by hardware, for example, by designing an integrated circuit. In addition, the present invention can also be realized by a program code of software that realizes the function of the embodiment. In this case, a storage medium in which the program code is recorded is provided in a computer, and a processor included in the computer reads the program code stored in the storage medium. In this case, the program code itself read from the storage medium realize the function of the above-described embodiment, and the program code itself and the storage medium storing the program code constitute the present invention. As a storage medium for supplying such a program code, for example, a flexible disk, a CD-ROM, a DVD-ROM, a hard disk, a solid state drive (SSD), an optical disk, a magneto-optical disk, a CD-R, a magnetic tape, a non-volatile memory card, a ROM, or the like is used.

In addition, the program code realizing the function described in the present embodiment can be implemented by a wide range of programs or script languages, for example, assembler, C/C++, perl, Shell, PHP, Python, and Java (registered trademark).

Furthermore, by distributing the program code of software that realizes the function of the embodiment via a network, the program code may be stored in a storage means such as a hard disk or a memory of the computer or in a storage medium such as a CD-RW or a CD-R, and the processor included in the computer may read and execute the program code stored in the storage means or the storage medium.

In addition, in the above-described embodiment, the control lines and information lines are those that are considered necessary for the description, and all the control lines and information lines on the product are not necessarily shown. All the configurations may be connected to each other.

What is claimed is:

1. A computer system comprising:
a processor;
a storage device connected to the processor; and
a network interface connected to the processor, wherein
the computer system is connected to an IT system including a plurality of nodes and a text generation system that generates an answer text according to a prompt for an instruction to execute a language processing task using a natural language processing model,
the computer system holds event log information for managing event logs of events that have occurred in the IT system and scope information for managing a scope that is a condition for acquiring event logs of events related to a designated event,
definition information for a plurality of scopes is stored in the scope information, and
the processor is configured to:
receive a fault handling request including information on a target event related to a fault;
generate related event information by collecting the event logs from the event log information based on each of the plurality of scopes; and
generate a prompt for an instruction to analyze a state of the IT system using each of a plurality of pieces of the related event information and generate a first analysis text indicating a result of the analysis, and transmit the prompt to the text generation system.

2. The computer system according to claim 1, wherein
the fault handling request includes information indicating a fault handling content, and
the processor is configured to generate information that is an answer to the fault handling request based on the fault handling content in the fault handling request and a plurality of first analysis texts, and output the generated information.

3. The computer system according to claim 1, wherein the processor is configured to compare each of the plurality of first analysis texts, and execute deduplication processing for deleting or merging a first analysis text including the same analysis content.

4. The computer system according to claim 2, wherein
the computer system holds a second analysis text indicating a result of analyzing a state of the IT system by the text generation system using event logs acquired in a state where the IT system is normal; and
the processor is configured to delete an analysis content that is the same as the second analysis text from the plurality of first analysis texts.

5. The computer system according to claim 1, wherein definition information for the scopes defined from a viewpoint based on a time or a configuration of the IT system is stored in the scope information.

6. The computer system according to claim 1, wherein the text generation system analyzes the state of the IT system with reference to information managed by an external system.

7. A fault handling support method executed by a computer system, the computer system including:
a processor;
a storage device connected to the processor; and
a network interface connected to the processor,
the computer system being connected to an IT system including a plurality of nodes and a text generation system that generates an answer text according to a prompt for an instruction to execute a language processing task using a natural language processing model,
the computer system holding event log information for managing event logs of events that have occurred in the IT system and scope information for managing a scope that is a condition for acquiring event logs of events related to a designated event,
definition information for a plurality of scopes being stored in the scope information, and
the fault handling support method comprising:
a first step of the processor receiving a fault handling request including information on a target event related to a fault;
a second step of the processor generating related event information by collecting the event logs from the event log information based on each of the plurality of scopes; and
a third step of the processor generating a prompt for an instruction to analyze a state of the IT system using each of a plurality of pieces of the related event information and generate a first analysis text indicating a result of the analysis, and transmitting the prompt to the text generation system.

8. The fault handling support method according to claim 7, wherein
the fault handling request includes information indicating a fault handling content, and
the fault handling support method includes a step of the processor generating information that is an answer to the fault handling request based on the fault handling content in the fault handling request and a plurality of first analysis texts, and outputting the generated information.

9. The fault handling support method according to claim 7, wherein the third step includes a fourth step of the processor comparing each of the plurality of first analysis texts, and executing deduplication processing for deleting or merging a first analysis text including the same analysis content.

10. The fault handling support method according to claim 8, wherein
the computer system holds a second analysis text indicating an analysis result by the text generation system using event logs acquired in a state where the IT system is normal; and
the third step includes a step of the processor deleting an analysis content that is the same as the second analysis text from the plurality of first analysis texts.

11. The fault handling support method according to claim 7, wherein definition information for the scopes defined from a viewpoint based on a time or a configuration of the IT system is stored in the scope information.

12. The fault handling support method according to claim 7, further comprising a step of the text generation system analyzing the state of the IT system with reference to information managed by an external system.
